(19) United States
(12) Patent Application Publication
(10) Pub. No.: US 2004/0130460 A1
(43) Pub. Date: Jul. 8, 2004

(54) Data collection unit for use with bulk vending machines

(76) Inventors: Troy Hinkle, Atlanta, GA (US); Brian King, Tucker, GA (US)

Correspondence Address: Troy Hinkle, Suite 201, 450 Cemetery Street, Norcross, GA, 30071, US

(21) Appl. No.: 10/336,698

(22) Filed: Jan. 3, 2003

(51) Int. Cl. H04Q 9/00; G08C 19/22

(52) U.S. Cl. 340/870.07

(57) ABSTRACT

A data collection unit used with bulk vending machines by means of creating, monitoring, storing, and transmitting, in digital format, the frequency of the switching of electrical switches though the ratcheting mechanism of a bulk vending machine. The device provides more accurate counts of mechanism rotations which permit the determination of accurate coin collection, vending material distributed, and frequency of use. The data collected is stored and available for secure download and transmission without the necessity of intervening elements which can create deliberate or accidental data reporting errors. The device accurately counts the rotations of the coin mechanism in a bulk vending machine and stores the data in a secure manner so that the number of rotations and the corresponding coin collection counts cannot be easily manipulated.

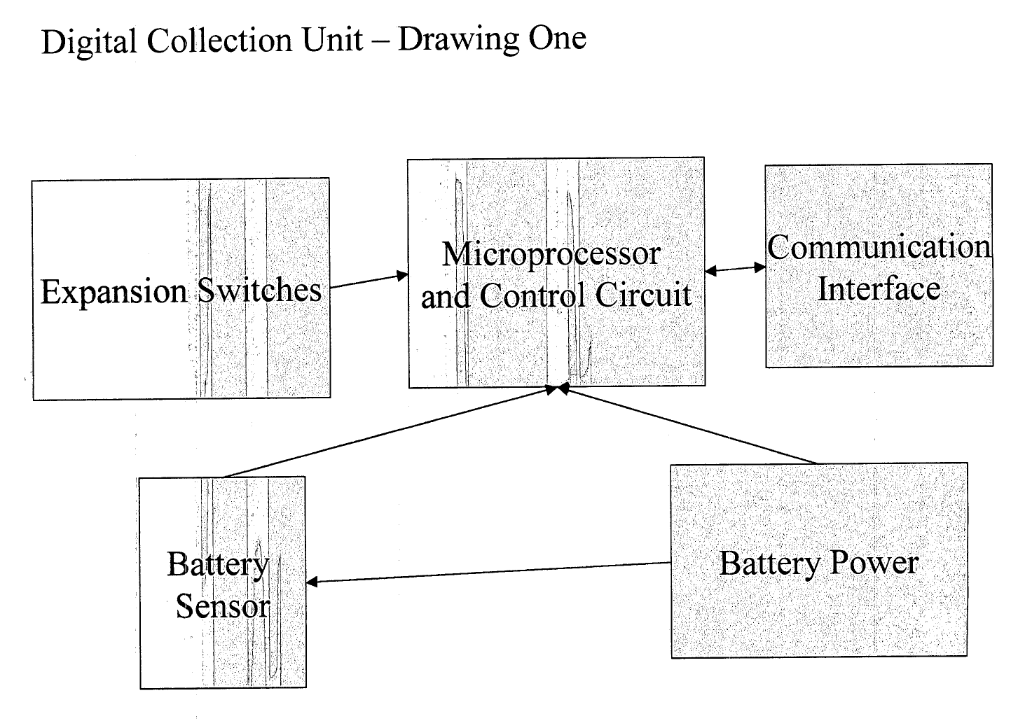

### BACKGROUND OF THE INVENTION

1. Field of the Invention

The present invention relates to a battery powered device which digitally collects data derived from a bulk vending machine. More specifically, the present invention relates to a data collection unit which attaches to the ratcheting mechanism of a bulk vending machine knob and counts the number of rotations the vending machine knob makes and collects the data in a digital format so that it may be stored and later transmitted in an accurate and secure manner.

2. Prior Art

Currently, bulk vending machines collect no data. A route driver physically collects the coins received by the machine and fills the bulk vending machine with the desired items, such as gumballs. At the end of a route, the driver reports the total amount of coins collected and the volume of goods delivered. This is a process which has been significantly abused in the past. The amount of money collected can be inaccurately reported, the amount of goods can be inaccurately reported, and no information is collected to make the machines “smarter.” Neither data related to frequency of use, number of machines per location, comparisons of machines at specific locations nor any other data is collected. The amount of cash collected by a bulk vending machine (e.g. a gumball machine) is counted and recorded by a manual process. If a machine is equipped to count the number of rotations made by the bulk vending machine knob, such count is typically accomplished by a mechanical counting device. Like an odometer in a car, this counter can be manipulated to show an inaccurate number of turns. Also, the number reported is oftentimes not correctly recorded by the delivery person tasked with this responsibility. When an inaccurate number of turns is reported, the number of coins collected does not accurately match the number of knob rotations. The real occurrence of theft by manipulating and/or inaccurately reporting the number of knob rotations costs the bulk vending industry a significant amount of money every year. Further, as described above, the only data that can currently be collected is the number of knob rotations. The present invention can record various dimensions of data so that bulk vending machines can collect data designed to assist in marketing as well as security. In addition, the data collection unit can permit the route driver to accurately determine system status which can better facilitate repairs should the need arise.

This invention uses electrical current and digital collection hardware and software to count the number of knob rotations and to store such data in a digital, unalterable format. The invention permits the end user to organize the data in a variety of ways. The data can be put into fields such as those describing not only the number of knob rotations since the last count but, a running count, the location of the machine, the route number, and the status of the machine. The device also collects and reports if the device itself has been tampered with or separated from its power source.

The invention accurately collects a wide range of data associated with the bulk vending machine and puts the data securely into a format that cannot be tampered with and can be transmitted securely without unnecessary route driver intervention. The invention is equipped to download the information to a hand held computer device so that it can then be batch delivered over the internet to a central collection server.

### SUMMARY OF THE INVENTION

The principle object of this invention is to digitally collect data from bulk vending machines (e.g. gumball machines). It is also an object of this invention to collect a wider range of data than that which is available using current methods.

A further object of this invention is to collect data from bulk vending machines in a digital format in a manner that is more secure and accurate that current methods and significantly lessens the potential for abuse.

Another object of this invention is to collect the data in a form that is easily, accurately, and securely able to be transmitted without unnecessary paperwork or route driver intervention.

The foregoing objects can be achieved by using a small battery powered device attached inside of a bulk vending machine. The device then runs electrical current through a switch at the ratcheting mechanism of the bulk vending machine knob so that knob rotations can be accurately counted and securely stored in a digital format. After a coin is inserted into the bulk vending machine and the user turns the vending machine knob, the circuit opens and closes correspondingly with the ratcheting action of the knob. The number of times that the circuit opens and closes is counted by the digital counting unit. The data is collected in a “per period” parameter (period data) and a running total parameter (cumulative data) so that the data can serve a variety of uses. Since the device counts are stored instantly, the data can be manipulated by the end user to determine a wide variety of both machine specific data as well as comparative data. The data can be compared both to other machines and can be used to compare machine use of the same machine within differing time frames.

The security objective is attained because the device is constantly checking its status as to battery life and switch status. Should a wire be cut, disconnected or damaged, the device stores this status data for later analysis. For example, if the battery is disconnected so that an accurate count does not occur, the occurrence of the disconnection is known and the potential cause of the disconnection may be discovered.

A further security feature is achieved because the device stores the data in a digital format which can be downloaded to a computer. Once the route driver attaches his computer device to the data collection unit and inputs a request to download data, the data is transmitted without driver intervention. This prevents counts from being manipulated by drivers. An accurate count of knob rotations is directly related to an accurate count of collected coins. Since the count cannot be manipulated, any inaccuracies in the reported coin collection total can easily be determined. The route driver retains the downloaded data in his computer device until it can be later transmitted to a central data collection facility.

### BRIEF DESCRIPTION OF DRAWING

Drawing 1 is of the Data Collection Unit. Drawing 1 depicts the microprocessor and control circuit, an interface for connecting to computer equipment, a power source, and expansion switches.

### DETAILED DESCRIPTION OF THE DRAWING

The switches connect to the ratcheting mechanism of the bulk vending machine. One Data Collection Unit can collect data from several distinct coin ratcheting mechanisms so that one Data Collection Unit can collect data from a bank of bulk vending machines. The microprocessor with the control circuit is battery powered. The control circuit is a low voltage circuit continuously running through the switches so that circuit disconnects can be monitored. The battery power is also monitored through a battery sensor so that when the battery begins to run low, a notification will be generated. The microprocessor collects and stores data received from the switches. The communication interface permits the data to be transmitted to a mobile computer device.

The data collection unit uses electrically erasable programmable read-only memory (EEPROM) to store collected data Period data (data collected from reading to reading) are accumulated for a period and are intended to be read out using a “request data” message (sent by the computer via the interface) and then reset by a “clear data” message. The period cycle counts cash drawer openings and turns for several coin mechanisms. The period unit resets counts of the number of times the unit is powered down. The cumulative data are items of data that are accumulated for the life of the digital collection unit and cannot be reset by a “clear data” message. Cumulative data also includes the total number of unit resets (another security feature) and total terminal connections.

As discussed, the data collection unit is designed to collect, store, and transmit data through the data communication equipment (computer device that can be attached to the communication interface) by sending and receiving messages and inquiries. All message characters are ASCII printing or control characters. All data elements in a message are delimited by commas or semicolons.

The data collection unit is designed to receive certain messages such as Clear Data, Request Data, Request Parameter, Request Status, and Set Parameter.

The data collection unit provides a Data Response to the specified Request Data inquiry. The Data Response message will include Cash Drawer data and the Coin Mechanism data for one cash drawer and the pre-determined number of coin mechanisms. The data collection unit can provide data responses in the form of an Error Response, an OK, or a specific Parameter Response.

A Status Response can include the Unit Identification and the version of the software running on the data collection unit. Other parameter responses can include specific data collection unit configurations, total termination connections, unit resets, and battery status.

I claim:

1. a data collection unit for use with bulk vending machines by using a battery power source, a microcontroller, electrical erasable programmable read-only memory, expansion switches, a data communication equipment interface, a control circuit and assorted electrical equipment to count, record, store and enable the transmission of, in a digital format, the opening and closing of electrical switches connected to corresponding bulk vending machine ratcheting mechanisms, rotating knobs, and/or a cash drawer.

2. a data collection unit that creates a means for collecting data from a number of bulk vending machines by attaching electrical expansion switches to the bulk vending machine's ratcheting mechanisms and cash drawer.

3. a data collection unit that runs low electrical current through each expansion switch as a means to identify and measure interruptions in the switch circuit.

4. a data collection unit that continually monitors its battery power source and can, when queried, report battery status.

5. a data collection unit that permits connectivity to data communication equipment as a means to interact with the data collection unit and download collected and stored data so that such data can be transmitted to a central data collection server without the necessity of paper reporting.
